(19) United States
(12) Patent Application Publication
(10) Pub. No.: US 2025/0031726 A1
(43) Pub. Date: Jan. 30, 2025

(54) USE OF AN EMULSIFIER DERIVED FROM RICINOLEIC ACID TO INCREASE THE ABSORPTION OF CALCIUM AND PHOSPHORUS IN THE DIGESTIVE TRACT OF FARM ANIMALS

(71) Applicant: GFSA Industria de Alimentação Animal LTDA, Apucarana (BR)

(72) Inventors: JOSÉ LUCIANO ANDRIGUETTO, Curtiba (BR); VALDEMIR VIECINSKI, Curtiba (BR)

(21) Appl. No.: 18/358,886

(22) Filed: Jul. 25, 2023

(51) Int. Cl. A23K 20/158; A23K 20/24; A23K 50/10; A23K 50/75

(52) U.S. Cl. CPC A23K 20/158; A23K 20/24; A23K 50/10; A23K 50/75

(57) ABSTRACT

The present disclosure describes the use of an emulsifier derived from ricinoleic acid to increase the absorption of calcium and phosphorus in the digestive tract of farm animals. Additionally, the present disclosure provides a composition and a dietary formulation containing an emulsifier derivative of ricinoleic acid and its production method.

### BACKGROUND TO THE INVENTION

Calcium and phosphorus are essential nutrients for the health and good performance of farm animals. Although most of the ingredients of plant and animal origin that make up the diet of these animals contain varying amounts of calcium and phosphorus, in general, the needs of the animal are not met only through such ingredients, and therefore it is routinely necessary to supplement in the balanced diets of farm animals.

The most commonly used sources of supplementation are divided into inorganic, such as limestone (calcitic or dolomitic), and phosphate salts (bicalcium, monocalcium, monoammonium, monosodium), and organic, such as bone meal, meat and bone meal, oyster shells and other molluscs. However, even though they are renewable sources, the continuous increase in the production of animal protein leads to a growing demand for these ingredients, with a consequent increase in their cost.

Among the different proteins of animal origin, the production of eggs demands a greater amount of calcium, since this is necessary for the formation of the shell. For egg producers, shell quality is of vital importance as it affects the total amount of marketable eggs, as broken, cracked or cracked eggs (microcracks) cannot be marketed, leading to significant economic losses. In addition, it is common for bone problems to occur in chickens from a certain age, since the production of eggs competes with the bones for calcium. Therefore, in the feed of laying birds, sources of calcium and phosphorus are used in high quantities, so as to ensure the quality of the shell and the longevity of the birds.

The cheapest source of animal origin is meat and bone meal, which contains, in addition to calcium and phosphorus, protein and essential amino acids. However, this raw material presents a series of problems, such as low availability, inconstant quality, and high risk of microbiological contamination, being the main source of Salmonella in poultry farms, which generates risk, including, for the consumer who will ingest contaminated eggs. Meanwhile, the replacement of meat and bone meal with dicalcium phosphate considerably reduces these risks, however, it increases the cost of feed, decreasing the profitability of the activity, which is highly dependent on the cost of feed inputs. In addition, phosphate has lower palatability, leading to the need to use vegetable oils to compensate for the reduction in consumption, with a much higher final cost.

With regard to breeding birds, responsible for generating broiler and laying chicks, eggs have high commercial value, given the value of the embryos, so that the guarantee in the quality of the eggs, the longevity of the birds and the absence of contamination have an even greater value. For these animals, phosphates are usually preferred to meat and bone meal, so these diets are usually more expensive, directly impacting the cost of chicks and, consequently, the cost of chicken and eggs, which are the two most accessible sources of protein to the consumer.

There is a need for methods and compositions for increasing uptake of minerals like calcium and phosphate in a subject eating and/or drinking a food and/or a beverage.

### SUMMARY

In some embodiments, disclosed herein is a method of increasing absorption of calcium and phosphorous in the digestive track of a subject, comprising administering an emulsifier derived from ricinoleic acid.

In some embodiments, disclosed herein is a composition comprising: an emulsifier derived from ricinoleic acid.

In some embodiments, the composition further comprises one or more mineral sources of calcium; and one or more sources of silica in solid form. In some embodiments, the one or more mineral sources of calcium is present in an amount of about 10 percent to about 30 percent by weight. In some embodiments, the one or more mineral sources of calcium the source of calcium is calcium carbonate. In some embodiments, the source of silica solid form is present in an amount of about 5 percent to about 30 percent by weight.

In some embodiments, the one or more sources of silica in solid form comprises diatomaceous earth. In some embodiments, the emulsifier derived from ricinoleic acid comprising ricinoleic acid present in an amount of about 10 percent to about 30 percent by weight. In some embodiments, the composition increases absorption of calcium and phosphorus in the digestive tract of farm animals. In some embodiments, the composition comprises part of a dietary formulation. In some embodiments, the composition comprises corn and soybean meal. In some embodiments, the composition is free of phosphates and meat and bone meal. In some embodiments, the composition is present in an amount of about 1 kg of the composition per ton of formulation or animal feed.

In some embodiments, disclosed herein is a method of producing a composition disclosed herein, characterized by comprising the steps of: (a) saponifying a fatty acid with a strong base, at a high temperature; and (b) mixing the fatty acid polyol obtained in step (a) with fatty acid salt, of high molecular weight. In some embodiments, step (a) occurs at a temperature between 50° C. and 220° C. In some embodiments, the strong base is selected from the group consisting of sodium hydroxide or potassium hydroxide. In some embodiments, the strong base of step (a) is present in a concentration of 5 to 25% of the total volume. In some embodiments, the strong base of step (a) is present between ⅓ and ⅔ of the fatty acid concentration. In some embodiments, the concentration of fatty acid in step (a) is from 15 to 60% of the total volume. In some embodiments, the fatty acid is an unsaturated fatty acid containing 15 to 20 carbon molecules. In some embodiments, the fatty acid is an unsaturated fatty acid containing 15 to 20 carbon molecules. In some embodiments, the fatty acid is ricinoleic acid. In some embodiments, the method is performed in time between 5 and 30 minutes.

In some embodiments, disclosed herein is a method of increasing the absorption of calcium and phosphorous of a farm animal, comprising administering a composition disclosed herein.

In some embodiments, disclosed herein is a method for increasing the absorption of calcium and phosphorus in the digestive tract of farm animals characterized by adding a composition, as disclosed herein, in the feed of farm animals. In some embodiments, about 1 kg of composition is added to 1 ton of feed from farm animals. In some embodiments, disclosed herein is a method of using an emulsifier derived from ricinoleic acid, wherein the emulsifier comprises a composition for augmented absorption of calcium and phosphorous in the digestive tract of farm animals, wherein the emulsifier comprises a soap and polyol of ricinoleic acid, wherein the emulsifier is added into a ton of animal feed in an amount of about 50 mg to about 2 kg, wherein the animal feed is a ration. In some embodiments, the farm animals are selected from: poultry, cows, pig, fish, or sheep. In some embodiments, the emulsifier improves the egg shell stability of poultry. In some embodiments, the animal feed improves animal productivity of a cow.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The present disclosure provides a composition and a diet formulation containing an emulsifier derived from ricinoleic acid. In addition, the present disclosure refers to the said composition and the use of the emulsifier derived from ricinoleic acid to maximize the absorption of calcium and phosphorus in the digestive tract of farm animals

Disclosed herein is the use of an emulsifier derived from ricinoleic acid to maximize the absorption of calcium and phosphorus in the digestive tract of farm animals. Additionally, the present disclosure provides urn composition It is a composition forming part of a formula in the diet containing the derived emulsifier in ricinoleic acid and methods of production.

The phytase enzyme has been used for decades in the monogastric feeding routine in order to maximize the absorption of phosphorus and calcium. This enzyme acts by releasing phosphorus and calcium bound to phytic acid, which is the storage form of phosphorus in plant tissues. Among the ingredients of plant origin commonly used for animal feed, such as corn, soybeans, wheat, rice, and other cereals and legumes, about 70% of phosphorus is present in the form of phytate, which is completely indigestible. Therefore, through the use of phytase, a considerable amount of this phosphorus becomes available to animals. In addition to phosphorus, phytate is also responsible for reducing calcium availability, since calcium and phosphorus tend to bind chemically spontaneously.

The Chinese patent application CN110916006 reveals a feed for chickens containing pine nut powder. More specifically the document refers to a ration comprising corn, wheat, salt and bark powder, pine nut powder, garlic powder and phosphorus in the form of phytate, in which the pine nut powder is composed of fatty acids, mainly oleic acid and linoleic acid.

Another relevant aspect in the metabolism of calcium and phosphorus is in the absorption of these at the intestinal level. In general, despite the use of phytase, about 20 to 30% of the phosphorus and up to 55% of the calcium in the diet of poultry and pigs is not absorbed, being lost in the excreta, since these minerals are only absorbed in ionized form. Salts from both organic and inorganic sources undergo dissociation upon encountering the acidic pH of the stomach or proventriculus, thus assuming its ionized form, which is amenable to absorption through the intestinal mucosa. However, as the contents advance in the intestinal tract, the pH increases, tending towards neutrality, causing calcium and phosphorus ions to associate again, forming insoluble salts. Thus, the absorption of calcium and phosphorus occurs only in the proximal ⅔ of the small intestine, in the duodenum and jejunum, but not in the ileum. In addition, absorption is affected by other factors that can interfere with the dissociation of salts, such as the degree of reduction of stomach pH, the presence of other mineral elements, such as magnesium.

As an alternative route of absorption, we highlight the one by means of lipids, in which phosphorus and calcium ions are absorbed very efficiently when bound to molecules such as: mono, di- and triglycerides, free fatty acids, steroids and phospholipids in general. In general, the fat present in the diet favors the absorption of calcium and phosphorus precisely because it offers binding sites to ions different from those generated by the formation of insoluble salts.

In general, the phospholipids found in food have digestibility greater than 90%, but are present in very low amounts, representing less than 5% of total phosphorus. In addition, its absorption may be affected by other factors, such as the hepatic secretion of bile salts, or by the use of emulsifying additives added to feed.

In this sense, the Chinese patent CN105076717 that reveals a food additive to improve the performance of animal production and ensure the health of the digestive tract, in which the food additive comprises acidity regulator, vegetable essential oil and auxiliary material. The acidity regulator comprising fumaric acid, sorbic acid and calcium formate; vegetable essential oil comprising cinnamic aldehyde, thymol and lycopene; and the said auxiliary material comprising phosphoric acid, lactic acid, hydrogenated palm oil.

The 2019 scientific paper by Keisuke Kawamoto M S et al. evaluated the hypothesis of diets high in fatty acids increasing phosphorus absorption. The article concludes that a diet rich in fatty acids induces an increase in phosphorus absorption. When looking for a relationship for this effect, the authors make use of intestinal alkaline phosphatase (IAP), which plays an important role in the intestinal absorption of phosphorus and long- or medium-chain triglycerides that increase the expression and/or activity of IAP.

Currently, one way to compensate for the losses that occur in the digestive process is the use of higher levels of calcium and phosphorus in the rations of farm animals. However, with this, the feeding of farm animals competes with other sectors, such as food intended for pet feeding and agriculture, for the availability of increasingly expensive raw materials, such as meat and bone meal and phosphates.

In addition to the greater demand for these ingredients, there is also the issue of the environmental impact caused by the amount of phosphorus present in animal waste. Excess phosphorus in the soil and especially in water bodies negatively affects the physicochemical balance of the environment, leading to the phenomenon known as eutrophication, with exaggerated growth of unwanted organisms such as algae. In several countries, there is also specific legislation on the amount of phosphorus, nitrogen and potassium that an animal production area can release in the form of waste, given the limited disposal of these wastes.

Another technical problem to be considered is the origin of phosphorus present in phosphates. The manufacture of phosphates involves the mining of phosphate rocks, which are subsequently treated with sulfuric acid. This is manufactured from sulfur extracted from mines. Both sulfur and phosphate rock mines have productivity limits, that is, they are not sustainable resources.

Although Brazil has important reserves of phosphate rock, production becomes insufficient to meet the demand of animal production and agriculture, and it is necessary to import phosphorus. Globally, there are few sulfur mines, which significantly increases the cost of sulfuric acid, imported in its entirety. Thus, the cost of Brazilian agricultural production is therefore vulnerable to the international availability of these commodities and the fluctuation of the exchange rate.

Thus, the improvement of the absorption of phosphorus and calcium by the farm animals has a high impact on the economy of production, on the reduction of the demand for important raw materials for other sectors, on the environmental impact of the activity and on the price of food of animal origin. However, there is currently no product in the animal feed market focused on such maximization.

The option for the exogenous enzyme phytase breaks down the phytate molecule, releasing the phosphate ions into the light of the digestive tract, but ensures that these ions will be absorbed, that is, that they will cross the wall of the intestine and reach the bloodstream. These ions can simply interact with calcium ions, forming insoluble salts, and ending up in excreta. The effect of phytases is variable and dependent on various dietary factors. The nutritional matrix of phytases varies greatly with the brand and the chemical nature of the same, with values of phosphorus, calcium, metabolizable energy, protein, and amino acids.

The option for the use of other emulsifiers presents only the effect of improvement in the absorption of lipids, without interacting significantly with the calcium ions and, mainly, of phosphorus of the diet. This can be evidenced by the nutritional matrices of these additives currently available in the market, which cite only their effect on the absorption of energy from diets.

The present disclosure provides a composition and the use of this to maximize the absorption of calcium and phosphorus in the digestive tract of farm animals. In addition, the use of an emulsifier derived from ricinoleic acid is provided for the formulation of this composition and its manufacturing method. In this way, the present disclosure allows the complete or partial exclusion of supplementary phosphorus sources from the diets of farm animals, and the significant reduction of calcium sources, providing an alternative to replace meat and bone meal in feed. Disclosed herein is a nutritional matrix of up to 200% total calcium, up to 200% digestible calcium, up to 200% total phosphorus, up to 200% digestible or available phosphorus, and up to 48,000 kcal of metabolizable energy.

The emulsifier disclosed herein increases the absorption of calcium and phosphorus present in the macroingredients of animal feed, such as corn and soybean meal, dispensing with the use of additional sources of phosphorus, such as meat and bone meal and dicalcium phosphate. Additional sources of calcium may still be needed, but in smaller amounts. In this way, the nutritional value of these ingredients, which are already used as a source of energy and protein, is maximized. In addition, the emulsifying action, combined with the lower use of a complex ingredient, such as meat and bone meal, increases the net energy of the diet, that is, it allows a much more efficient use of the energy of the feed, improving feed conversion. The greater energy availability also allows for better immune response and greater longevity of the animals. The emulsifier also provides the reduction of the risk of microbiological contamination by meat and bone meal. This represents a minimization of sanitary challenges, as a gateway of possible contaminants is closed, allowing a decrease in the use of medicines (antibiotics) and a healthy economic activity, contributing to better animal welfare.

In the case of egg production, as the emulsifier derived from ricinoleic acid of the present disclosure is transferred to the shell membrane, the proportion of eggs with shell problems is significantly reduced, which would make them unsaleable, maximizing productivity. It is usual to lose up to 7% of the eggs produced daily by shell problems. With the use of the current invention, this level is reduced below 2%, that is, increasing by up to 5% the amount of saleable eggs, with excellent cost-benefit ratio. In breeding birds, the proportion of incubatable eggs can also increase. The ricinoleic acid derivative disclosed herein is also able to reduce the problems of chickens and other laying birds in relation to poor bone calcification, frequent when the demand for calcium and phosphorus is not met throughout the life of the bird, reducing the mortality of the birds and increasing their productive longevity.

The composition of the present disclosure represents only a tiny amount of the feed formulation of the animal feed, allowing the inclusion of other raw materials. In numerical terms, the composition may comprise about 0.1% of the feed formulation, against about 1.5% of phosphates and 5% of animal meal.

In addition to all the direct benefits obtained from the emulsifier, the present disclosure allows the elimination of animal meal from the formulations, which brings the following benefits: exclusion of bone fragments that can cause failures in the feed distribution systems to the animals, which could generate a disruption in the feed supply, reduction of the proliferation of pests, such as rodents in feed mills, contributing directly to a healthier environment for the farm animal and the employee, and more safety for the consumer, optimization of the cost of feed, by dispensing with the inclusion of additional raw materials, reduction of vulnerability to cost variation of phosphorus sources from other sectors, such as the reduction in the slaughter of cattle, affecting the production of meat and bone meal, the increase in the demand for these flours by the petfood market, the increase in the demand for phosphate by agriculture or the exchange rate variation, and reduction of the need for built physical space. This economy, combined with the reduction of up to 40% in the volume of raw materials, significantly reduces the carbon footprint of the activity. Additional benefits may include reduction of excretion of much of the calcium and phosphorus ingested, avoiding environmental contamination. In aquatic animal feed, the present disclosure may have less impact on the phenomenon of eutrophication, due to the lower amount of phosphorus included in the diets, but also can improve agility in processing in feed mills, saving energy, time and labor, facilitating the management of phosphorus for small producers, enabling small-scale production with great social impact. The present disclosure provides greater security of supply and price, since the producer can stock without compromising space and time for its superior validity to animal meal. The present disclosure creates a possibility of providing a product 100% free of cross-contamination of other species, with reduced health risk to the consumer, such as bovine spongiform encephalitis (mad cow).

Although the use of ricinoleic acid and its derivatives as an emulsifier is known and applied in the human food industry, especially confectionery and other industrialized foods, this application is always linked to the objective of improving the miscibility of fats with substances of a polar nature, in aqueous medium, improving the sensory aspects of the food, and never to the objective of maximizing the absorption of calcium and phosphorus. This concern is usually not present in the formulation of processed foods. In addition, although these emulsifiers have their use approved in animal feed, it would only aim to increase the absorption of fat/energy from the diet.

The present disclosure improves the use of emulsifiers with the innovative and specific purpose of maximizing the absorption of calcium and phosphorus, including the creation of a nutritional matrix that contemplates the levels of calcium, phosphorus and energy to be considered in the formulation of diets, via the use of the emulsifier. From the application of this nutritional matrix, the possibility of excluding additional sources of calcium and phosphorus, such as phosphates and meat and bone meal, is evident.

In most diets, it is sought to achieve an approximate level of 0.4% of available phosphorus, from an amount of total phosphorus around 0.5 to 0.65%. Considering the amount and digestibility of phosphorus present in the macroingredients (energy and protein sources), we usually have around 0.1% of phosphorus available. With the use of state-of-the-art phytases, 0.2 to 0.25% of available phosphorus can be achieved. So, in general, 20 to 60 kg of phosphates or meat and bone meal per ton of feed are used as sources of the missing 0.15 to 0.2% of phosphorous. With the use of the present invention, it is possible to make available a greater amount of the total phosphorus present in the macroingredients, reaching the requirement of 0.4% of available phosphorus, without the need to include phosphates or flours.

The present disclosure contemplates the use of an emulsifier derived from ricinoleic acid, with high activity in the absorption of calcium and phosphorus in the digestive tract of farm animals. This emulsifier is a mixture of fatty acid polyol and ricinoleic acid salts, of high molecular weight, obtained from the saponification reaction of ricinoleic acid with a strong base, at high temperature. The hydroxyl and carboxyl endings of the derivative of ricinoleic acid of the present disclosure react with the calcium and phosphorus ions, preventing them from binding in the form of insoluble salts, and allowing their absorption in the form of lipid micelles. In some embodiments, the ricinoleic acid derivative has a chemical structure:

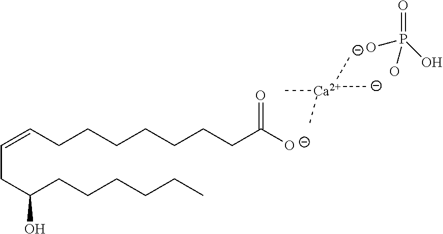

The ricinoleic acid derivative disclosed herein has a strong emulsifying effect, which intensifies the formation of small micelles in the light of the digestive tract, which maximizes the absorption of lipids from the diet. When micelles form, the emulsifier drags calcium and phosphorus ions along with them, maximizing the absorption of minerals. In other words, the calcium and phosphorus that would otherwise be lost are thus absorbed in the form of phospholipids, throughout the small intestine.

The application of the present disclosure in the formulation of diets of farm animals is possible thanks to the development of the nutritional matrix of the emulsifier. It brings the corresponding levels of calcium, phosphorus and metabolizable energy that the animals will absorb from the ingredients of the diet, with the use of the emulsifier. These values are applied in animal feed formula optimization programs, so that they are included in the calculation of the digestible amount of each of the nutrients. By optimizing the dietary formulation, the animal feed can exclude phosphates and meat and bone meal, meeting the requirements of the animals through only the phosphorus of the other dietary formulation, such as corn and soybean meal. Depending on the species and animal category, additional sources of calcium may be required. In some cases, limestone is used as an extremely low-cost source of calcium.

The present disclosure also refers to a composition to increase the absorption of calcium and phosphorus in the digestive tract of farm animals that comprises: an emulsifier derived from ricinoleic acid, a mineral source of calcium, and a source of silica in solid form. In some cases, the emulsifier comprises ricinoleic acid, one or more mineral sources of calcium, and one or more mineral sources of calcium. In some embodiments of the composition, the mineral source of calcium is present in an amount of about 10 percent to about 30 percent weight/weight. In some embodiments, the source of calcium is calcium carbonate. In some embodiments, the source of silica in solid form is present in an amount of about 5 percent to about 30 percent weight/weight. In some embodiments, the source of silica in solid form is diatomaceous earth. In a particular modality of the present disclosure the emulsifier derived from ricinoleic acid is present in an amount of about 10 percent to about 30 percent weight/weight.

The present disclosure also contemplates a diet formulation comprising the composition of the present disclosure. In some embodiments, this diet formulation also comprises corn and soybean meal and, in some embodiments, the formulation is free of phosphates and meat and bone meal. The diet formulation comprises about 1 kg of the composition per ton of formulation.

The present disclosure also contemplates the method of production of a composition to increase the absorption of calcium and phosphorus in the digestive tract of farm animals comprising the steps of: saponifying a fatty acid with a strong base, at a high temperature; and mixing the fatty acid polyol obtained in step (A) with fatty acid salts, of high molecular weight.

In some embodiments, step (a) of the method occurs at a temperature between 5° and 220° C. In a modality of the present invention, the strong base of step (a) is selected from the group consisting of sodium or potassium hydroxide. In a preferential modality of the present invention, the strong base of step (a) is present in a concentration of 5 to 25% of the total volume, even more preferred, the concentration of the strong base is between ⅓ and ⅔ of the concentration of the fatty acid established. In a particular modality of the present invention, concentration of the fatty acid of step (a) is from 15 to 60% of the total volume. In some embodiments, the fatty acid is an unsaturated fatty acid containing 15 to 20 carbon molecules. In some embodiments, the fatty acid is ricinoleic acid.

The present disclosure also contemplates the use of a composition disclosed herein for the production of a ration to increase the absorption of calcium and phosphorus in the digestive tract of farm animals.

The present disclosure also provides a method to increase the absorption of calcium and phosphorus in the digestive tract of farm animals that comprises adding the composition of the present disclosure in the feed of farm animals. Preferably, about 1 kg of composition is added to 1 ton of feed from farm animals.

The present disclosure provides a composition and the use of this to maximize the absorption of calcium and phosphorus in the digestive tract of farm animals. In addition, the use of an emulsifier derived from ricinoleic acid is provided for, as well as a formulation of the emulsifier and its manufacturing method. In this way, the present disclosure allows the complete exclusion of supplementary phosphorus sources from the diets of farm animals, and the significant reduction of calcium sources, providing an alternative to replace meat and bone meal in feed. In some embodiments, a nutritional matrix of up to 200% total calcium, up to 200% digestible calcium, up to 200% total phosphorus, up to 200% digestible or available phosphorus, and/or up to 48,000 kcal of metabolizable energy.

### Certain Terminology

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The terms “subject,” “individual,” or “patient” are often used interchangeably herein. A “subject” can be a biological entity containing expressed genetic materials. The biological entity can be a plant, animal, or microorganism, including, for example, bacteria, viruses, fungi, and protozoa. The subject can be tissues, cells and their progeny of a biological entity obtained in vivo or cultured in vitro. The subject can be a mammal. The mammal can be a human. The subject may be diagnosed or suspected of being at high risk for a disease. In some cases, the subject is not necessarily diagnosed or suspected of being at high risk for the disease.

As used herein, the term “about” a number refers to that number plus or minus 10% of that number. The term “about” a range refers to that range minus 10% of its lowest value and plus 10% of its greatest value.

### EXAMPLES

The following examples are intended to illustrate but not limit the disclosed embodiments.

### Example 1: Weight Gain in Broilers

In order to assess the effect of the use of the emulsifier on calcium and phosphorus absorption in growing animals, a study comparing weight gain in hens up to 21 days of age was carried out. The study was conducted in integration in the state of Santa Catarina, wherein animals were split into batches to receive feeds with the emulsifier and then have their weight gains compared to similar batches, with the same age and weight, that served as controls and did not receive the emulsifier.

More specifically, the animals were split into 2 groups, wherein group 1 received feed with the emulsifier and group 2 received conventional feed without the addition of the emulsifier. The test results are illustrated in Table 1 below. A month of use of the emulsifier formulation improved the weight of the hens tested, demonstrating nutritional improvement via the emulsifier.

TABLE 1
Weight gain comparison in hens that received the emulsifier up to 21 days of age.

| | | WEIGHT IN GRAMS PER DAY | | | | |
|---|---|---|---|---|---|---|
| | HOUSED HENS | 1 | 7 | 14 | 21 | 28 |
| Group 1 - with emulsifier | 37,000 | 40 | 160 | 460 | 1037 | 1754 |
| Group 2 - control | 37,000 | 40 | 155 | 450 | 1034 | 1617 |

### Example 2: Comparison Between Feed Formulations for Hens

The feed formulations used in the study about weight gain, with and without the emulsifier of the present invention, and the costs thereof are illustrated in Tables 2 to 5 below. Tables 2 and 3 depict the feed formulations with and without the emulsifier and Tables 4 and 5 depict the nutrient levels of feeds with and without the emulsifier. The results of the experiment show improved nutritional outcomes with the ricinoleic acid formulations. As can be observed from the table 2-5, the product containing the emulsifier is cheaper than that without the emulsifier. Table comparison shows that the feed formulations with the emulsifier comprising ricinoleic acid, besides being cheaper, thus reducing production costs, increase calcium and phosphorus content, from 1.045% to 1.185% and from 0.550% to 0.624%, respectively.

TABLE 2
Feed formulation for hens without the emulsifier

| Ingredient | Cost per kg | Amount (kg) |
|---|---|---|
| Corn | 1.500 | 564.327 |
| Soybean meal | 2.000 | 287.468 |
| Offal meal | 3.900 | 50.000 |
| Meat and bone meal | 2.320 | 40.000 |
| Young poultry oil | 6.000 | 18.000 |
| Degummed soybean oil | 6.740 | 14.094 |
| Liquid methionine | 12.150 | 4.622 |
| Lysine 60% | 7.140 | 3.705 |
| Sodium bicarbonate | 2.590 | 3.700 |
| Premix INICIAL feed | 18.810 | 2.900 |
| Phosphate | 4.270 | 2.779 |
| Limestone | 0.300 | 2.549 |
| Granulated salt | 0.610 | 1.582 |
| L-threonine | 9.680 | 1.530 |
| Calibrin | 10.230 | 1.000 |
| Essential oil | 18.750 | 0.500 |
| Anticoccidian Premix feed | 53.000 | 0.500 |
| L-Valine | 20.220 | 0.494 |
| Organic selenium | 27.500 | 0.150 |
| Precizyon X50 | 1.000 | 0.100 |
| TOTAL | 2.148 | 1,000.000 |

TABLE 3
Pre-starter feed formulation for hens with the emulsifier

| Ingredient | Cost per kg | Amount (kg) |
|---|---|---|
| Corn | 1.500 | 564.327 |
| Soybean meal | 2.000 | 287.468 |
| Offal meal | 6.220 | 50.000 |
| Young poultry oil | 6.000 | 18.000 |
| Degummed soybean oil | 6.740 | 14.094 |
| Limestone | 0.300 | 9.010 |
| Liquid methionine | 12.150 | 4.622 |
| Sodium bicarbonate | 2.590 | 3.700 |
| Lysine 60% | 7.140 | 3.491 |
| Premix INICIAL feed | 18.810 | 2.899 |
| Granulated salt | 0.610 | 2.041 |
| L-Threonine | 9.680 | 1.441 |
| Calibrin | 10.230 | 1.000 |
| Emulsifying oil | 33.000 | 1.000 |
| Essential oil | 18.750 | 0.500 |
| Premix | 53.000 | 0.500 |
| anticoccidian feed | | |
| L-Valine | 20.220 | 0.411 |
| Organic selenium | 27.500 | 0.150 |
| Precizyon X50 | 1.000 | 0.100 |
| TOTAL | 2.135 | 1,000.000 |

TABLE 4
Nutrient levels in formulations without the addition of emulsifier

| Nutrient | Content | | | Intake |
|---|---|---|---|---|
| Moisture | 10.620% | | MIN | — |
| Dry matter | 88.403% | | MIN | — |
| Metabolic energy | 3,149.999 | kcal/kg | MAX | 3,151.000 |
| | | | MIN | 3,149.000 |
| Enzyme energy | 50,000 | kcal | MIN | — |
| Crude protein | 23.688% | | — | — |
| Enzymatic protein | 0.060% | | — | — |
| Ether extract | 6.912% | | — | — |
| Crude fiber | 2.340% | | — | — |
| Calcium | 1.045% | | — | — |
| Ca:Pd | 1.900 | | MIN | 1.900 |
| Available phosphorus | 0.550% | | MIN | 0.550 |
| Sodium | 0.220% | | MIN | 0.220 |
| Chlorine | 0.209% | | — | — |
| Potassium | 0.755% | | MIN | — |
| Electrolyte balance | 230,002 | mEq/kg | MIN | 230.000 |

| | | | |
|---|---|---|---|
| Digestible lysine | 1.300% | MIN | 1.300 |
| Digestible methionine | 0.717% | — | — |
| Digestible methionine + cysteine | 0.994% | — | — |
| Sulph:Lys | 0.765% | MIN | 0.765 |
| Digestible tryptophan | 0.231% | — | — |
| Trypt:Lys | 0.178 | — | — |
| Digestible threonine | 0.871% | — | — |
| Threo:Lys | 0.670 | MIN | 0.670 |
| Digestible arginine | 1.365% | — | — |
| Arg:Lys | 1.050 | MIN | 1.050 |
| Digestible leucine | 1.647% | — | — |

TABLE 5
Nutrient levels in formulations with the addition of emulsifier

| Nutrient ¤ | Content ¤ | | ¤ | Intake¤ |
|---|---|---|---|---|
| Moisture ¤ | 10.721% ¤ | | MIN ¤ | [symbol] |
| Dry matter ¤ | 88.212% ¤ | | MIN ¤ | [symbol] |
| Metabolic energy ¤ | 3,150.004 | kcal/kg ¤ | MAX ¤ | 3,151.000 ¤ |
| | | | MIN ¤ | 3,149.000 ¤ |
| Enzyme energy ¤ | 50,000 | kcal ¤ | MIN ¤ | [symbol] |
| Crude protein ¤ | 23.446% ¤ | | [symbol] | [symbol] |
| Enzymatic protein ¤ | 0.060% ¤ | | [symbol] | [symbol] |
| Ether extract ¤ | 6.426%¤ | | [symbol] | [symbol] |
| Crude fiber ¤ | 2.423% ¤ | | [symbol] | [symbol] |
| Calcium ¤ | 1.185% ¤ | | [symbol] | [symbol] |
| Ca:P ¤ | 1.900 ¤ | | MIN ¤ | 1.900 ¤ |
| Available phosphorus ¤ | 0.624% ¤ | | MIN ¤ | 0.550 ¤ |
| Sodium ¤ | 0.220% ¤ | | MIN ¤ | 0.220 ¤ |
| Chlorine ¤ | 0.225% ¤ | | [symbol] | [symbol] |
| Potassium ¤ | 0.773% ¤ | | MIN ¤ | [symbol] |
| Electrolyte balance ¤ | 230,001 | mEq/kg ¤ | MIN ¤ | 230.000 ¤ |

| | | | |
|---|---|---|---|
| Digestible lysine ¤ | 1.300% ¤ | MIN ¤ | 1.300 ¤ |
| Digestible methionine ¤ | 0.710% ¤ | [symbol] | [symbol] |
| Digestible methionine + cyteine ¤ | 0.995% ¤ | [symbol] | [symbol] |
| Sulph:Lys ¤ | 0.765% ¤ | MIN ¤ | 0.765 ¤ |
| Digestible tryptophan¤ | 0.238% ¤ | [symbol] | [symbol] |
| Trypt:Lys ¤ | 0.183% | [symbol] | [symbol] |
| Digestible arginine ¤ | 1.365% ¤ | [symbol] | [symbol] |
| Arg:Lys ¤ | 1.050 ¤ | MIN ¤ | 1.050 |
| Digestible leucine¤ | 1.665%¤ | [symbol] | [symbol] |

### Example 3: Assessment of Shell Quality in Laying Hen Farms

In order to assess the effect of the use of the emulsifier on the calcium and phosphorus absorption in laying hens, several studies on laying hens from different farms were carried out. The studies comprised the analysis of animals before and after the feed with the formulation containing the emulsifier comprising ingredients shown in Table 3.

More specifically, an assessment of the shell quality in laying hens was conducted by collecting the eggs before and after feeding the animals with the formulation containing the emulsifier. Hens from farms in the states of Espírito Santo (350,000 hens), São Paulo (2,000,000 hens), Paraná (1,100,000 hens), and Minas Gerais (850,00 hens) were fed with a pair of feed formulas, one without and another one with the product of the present invention.

Laid eggs were collected after feeding the hens with regular feed and later with the feed containing the emulsifier of the present invention. Data obtained from the analysis of the eggs from the farms in Espírito Santo, São Paulo, Paraná, and Minas Gerais are included in Tables 6 to 9 below, the beneficial effects on the shells being emphasized thereof, among them the reduction in cracks of chicken eggs. Data presented in Table 6 shows that the use of the emulsifier in poultry feed produces an increase in egg weight, a 2% improvement in crack occurrences as well as an improvement in other shell defects. The number of failed eggs dropped to zero and shell porosity was reduced.

Data presented in Table 6 shows that the use of the emulsifier in poultry feed produces an increase in egg weight, a 2% improvement in crack occurrences as well as an improvement in other shell defects. The number of failed eggs dropped to zero and shell porosity was reduced. It can be observed in Table 7 that there was an increase in egg weight in all assessed farms in the state of São Paulo and a decrease in crack occurrences. Other defects such as deformations, thin shells, and failed eggs also had a significant reduction. Table 8 shows data from eggs collected before and after the use of the emulsifier in the feed formulation on a farm in the state of Paraná. Data comparison, as expected, showed a reduction in crack occurrences, deformations, porosity, and thin shells Data shown in Table 9 refer to the study carried out on a farm in the state of Minas Gerais, wherein, as in the other farms, an increase in egg weight, a 2% improvement in crack occurrences, and an improvement in other shell defects were observed. The number of failed eggs, porosity, and shell deformation were reduced.

TABLE 6
Eggshell quality report - Farm in Espírito Santo
FLOCK: 350,000 HENS

| | | AGE/ | PROD. | REAL | | | | THIN | | |
|---|---|---|---|---|---|---|---|---|---|---|
| FARMS | LINEAGE | WEEKS | 01/22 | WEIGHT | CRACK | DEFORM. | FAILED | SHELL | DIRTY | POROUS |
| 1A | HISEX | 65 | 1.82 | 60.7 | 1 | 0 | 0 | 0 | 0 | 0 |
| | WHITE | | | | | | | | | |
| 1B | HISEX | 65 | 2.1 | 62.6 | 2 | 0 | 0 | 0 | 0 | 0 |
| | BROWN | | | | | | | | | |
| 3 | BOVANS | 81 | −0.52 | 61 | 1 | 2 | 0 | 1 | 0 | 1 |
| | WHITE | | | | | | | | | |
| 5 | ISA | 77 | −1.17 | 60.9 | 2 | 0 | 1 | 1 | 0 | 2 |
| | BROWN | | | | | | | | | |
| AVERAGE | | 72 | 0.6 | 61.3 | 2.5 | 0.8 | 0.4 | 0.4 | 0.0 | 1.3 |

TECHNICAL VISIT 8 WEEKS LATER

| | | | | | | | | | | |
|---|---|---|---|---|---|---|---|---|---|---|
| 1A | HISEX | 73 | 2.33 | 61 | 0 | 0 | 0 | 0 | 0 | 0 |
| | WHITE | | | | | | | | | |
| 1B | HISEX | 73 | 2.53 | 62.5 | 0 | 0 | 0 | 0 | 0 | 0 |
| | BROWN | | | | | | | | | |
| 3 | BOVANS | 89 | −0.22 | 61.5 | 0 | 2 | 0 | 1 | 0 | 0 |
| | WHITE | | | | | | | | | |
| 5 | ISA | 85 | −1.56 | 61.7 | 1 | 0 | 0 | 0 | 0 | 1 |
| | BROWN | | | | | | | | | |
| AVERAGE | | 80 | 0.8 | 61.7 | 0.4 | 0.8 | 0.0 | 0.4 | 0.0 | 0.4 |

| | | | | | | | | |
|---|---|---|---|---|---|---|---|---|
| DIFFERENCE | 0.2 | 0.4 | 2.1 | 0.00 | 0.4 | 0.0 | 0 | 0.8 |

TABLE 7
Eggshell quality report - Farms in São Paulo
FLOCK: 2,000,000 HENS

| | | | AGE/ | PROD. | | DIFF. | REAL | | DIFF. | |
|---|---|---|---|---|---|---|---|---|---|---|
| | FARMS | LINEAGE | WEEKS | 11/21 | STD % | % | WEIGHT | STD % | % | CRACK |
| MONTEIRO | 517B- R07 | DEKALB | 61 | 87.76 | 87.4 | 0.36 | 57.6 | 64 | −6 | 2 |
| FARM | | WHITE | | | | | | | | |
| | 521D- R05 | LOHMANN | 48 | 96.59 | 89.3 | 7.29 | 55.5 | 59.2 | −4 | 0 |
| | | WHITE | | | | | | | | |
| | 532D- R04 | HY LINE | 27 | 83.37 | 96 | −12.6 | 52.1 | 59 | −7 | 0 |
| | | W80 | | | | | | | | |
| | 511B- R01 | BOVANS | 74 | 88.11 | 83.8 | 4.31 | 61.1 | 64.8 | −4 | 2 |
| | AVERAGE | | 52 | 89.0 | 89.1 | −0.17 | 56.6 | 61.8 | −5 | 1.7 |

TECHNICAL VISIT 9 WEEKS LATER

| MONTEIRO | 517B- R07 | DEKALB | 70 | 80.09 | 85.2 | 1.2 | 58.8 | 65 | −6 | 0 |
|---|---|---|---|---|---|---|---|---|---|---|
| FARM | | WHITE | | | | | | | | |
| | 521D- R05 | LOHMANN | 57 | 94.42 | 93.7 | 0.72 | 59.3 | 63.5 | −4 | 0 |
| | | WHITE | | | | | | | | |
| | 532D- R04 | HY LINE | 36 | 89.15 | 96 | −3.5 | 54.1 | 61 | −7 | 0 |
| | | W80 | | | | | | | | |
| | 511B- R01 | BOVANS | 83 | 87.75 | 81.6 | 6.15 | 62.8 | 65.5 | −3 | 1 |
| | AVERAGE | | 61 | 87.9 | 89.1 | 1.1 | 58.8 | 63.75 | −5 | 0.4 |
| DIFFERENCE | | | | | | 1.31 | 2.2 | | 0 | 1.3 |
| III | 524B- R19 | DEKALB | 46 | 83.22 | 93 | 9.78 | 61 | 62 | −1 | 0 |
| FARM | | WHITE | | | | | | | | |
| | 510B- R13 | EMPTY | 0 | 0 | 0 | 0 | 0 | 0 | 0 | 0 |
| | 528B- R05 | BOVANS | 38 | 92.31 | 95.5 | −3.19 | 56.8 | 61.1 | −4 | 0 |
| | 519B- R07 | H&N | 58 | 81 | 93.5 | −12.5 | 62.3 | 63.3 | −1 | 2 |
| | | WHITE | | | | | | | | |
| | AVERAGE | | 47 | 85.51 | 94 | −8.49 | 60.0 | 62.133 | −2 | 1.11 |

TECHNICAL VISIT 9 WEEKS LATER

| III | 524B- R19 | DEKALB | 55 | 94.73 | 91.6 | 3.13 | 61.6 | 63 | −1 | 0 |
|---|---|---|---|---|---|---|---|---|---|---|
| FARM | | WHITE | | | | | | | | |
| | 510B- R13 | EMPTY | 0 | 0 | 0 | 0 | 0 | 0 | 0 | 0 |
| | 528B- R05 | BOVANS | 47 | 82.62 | 93.6 | −11 | 61.6 | 61.8 | −0.2 | 0 |
| | 519B- R07 | H&N | 67 | 86.55 | 90.6 | −4.05 | 63.5 | 64 | −0.5 | 0 |
| | | WHITE | | | | | | | | |
| | AVERAGE | | 56 | 88.0 | 91.9333 | −3.97 | 62.2 | 62.9 | −1 | 0 |
| DIFFERENCE | | | | | | 4.52 | 2.2 | | 1 | 0.56 |
| TREVO | R05 | VAZIO | 0 | 0 | 0 | 0 | 0 | 0 | 0 | 0 |
| FARM | R09 | BOVANS | 45 | 96.41 | 88.7 | 7.71 | 62.1 | 63.3 | −1 | 1 |
| | R12 | BOVANS | 60 | 98.2 | 93.6 | 4.6 | 61.5 | 61.8 | −0.3 | 2 |
| | AVERAGE | | 53 | 97.31 | 91.2 | 6.16 | 61.8 | 62.6 | −0.8 | 2.50 |

TECHNICAL VISIT 9 WEEKS LATER

| | | | | | | | | | | |
|---|---|---|---|---|---|---|---|---|---|---|
| TREVO | R05 | EMPTY | 0 | 0 | 0 | 0 | 0 | 0 | 0 | 0 |
| FARM | R09 | SOVANS | 54 | 96.4 | 91.9 | 4.52 | 62 | 63 | −1 | 0 |
| | R12 | BOVANS | 69 | 90.4 | 86.8 | 3.6 | 62.8 | 62.4 | 0.4 | 0 |
| | AVERAGE | | 61.5 | 93.4 | 89.4 | 4.1 | 62.4 | 62.7 | −0.3 | 0 |

| | | | | |
|---|---|---|---|---|
| DIFFERENCE | −2.10 | 0.6 | 0.50 | 2.50 |

| | | | | THIN | | |
|---|---|---|---|---|---|---|
| | FARMS | DEFORM. | FAILED | SHELL | DIRTY | POROUS |
| MONTEIRO | 517B- R07 | 4 | 1 | 1 | 0 | 0 |
| FARM | | | | | | |
| | 521D- R05 | 1 | 0 | 0 | 4 | 0 |
| | 532D- R04 | 1 | 0 | 0 | 3 | 0 |
| | 511B- R01 | 5 | 1 | 1 | 1 | 1 |
| | AVERAGE | 4.6 | 0.8 | 0.8 | 3.3 | 0.4 |
| TECHNICAL VISIT 9 WEEKS LATER | | | | | | |
| MONTEIRO | 517B- R07 | 2 | 0 | 0 | 1 | 0 |
| FARM | | | | | | |
| | 521D- R05 | 1 | 0 | 0 | 4 | 0 |
| | 532D- R04 | 0 | 0 | 0 | 3 | 0 |
| | 511B- R01 | 3 | 0 | 0 | 0 | 1 |
| | AVERAGE | 2.5 | 0 | 0 | 3.3 | 0.4 |
| DIFFERENCE | | 2.1 | 0.8 | 0.8 | 0.0 | 0.0 |
| III | 524B- R19 | 3 | 4 | 0 | 0 | 0 |
| FARM | | | | | | |
| | 510B- R13 | 0 | 0 | 0 | 0 | 0 |
| | 528B- R05 | 0 | 0 | 0 | 0 | 0 |
| | 519B- R07 | 3 | 1 | 0 | 2 | 0 |
| | AVERAGE | 3.33 | 2.78 | 0 | 1.11 | 0 |
| TECHNICAL VISIT 9 WEEKS LATER | | | | | | |
| III | 524B- R19 | 0 | 0 | 0 | 2 | 0 |
| FARM | | | | | | |
| | 510B- R13 | 0 | 0 | 0 | 0 | 0 |
| | 528B- R05 | 0 | 0 | 0 | 0 | 0 |
| | 519B- R07 | 0 | 0 | 0 | 0 | 0 |
| | AVERAGE | 0 | 0 | 0 | 1.11 | 0 |
| DIFFERENCE | | 3.33 | 2.78 | 0 | 0 | 0 |
| TREVO | R05 | 0 | 0 | 0 | 0 | 0 |
| FARM | R09 | 2 | 0 | 1 | 1 | 0 |
| | R12 | 3 | 0 | 0 | 0 | 0 |
| | AVERAGE | 4.17 | 0.00 | 0.8 | 0.8 | 0.00 |
| TECHNICAL VISIT 9 WEEKS LATER | | | | | | |
| TREVO | R05 | 0 | 0 | 0 | 0 | 0 |
| FARM | R09 | 0 | 0 | 0 | 0 | 0 |
| | R12 | 0 | 0 | 0 | 0 | 0 |
| | AVERAGE | 0 | 0 | 0 | 0 | 0 |

| | | | | | |
|---|---|---|---|---|---|
| DIFFERENCE | 4.17 | 0 | 0.8 | 0.8 | 0 |

TABLE 8
Eggshell quality report - Farm in Paraná

| | | | | | | THIN | |
|---|---|---|---|---|---|---|---|
| FARMS | LINEAGE | AGE | WEIGHT | CRACK | DEFORMED | SHELL | POROUS |
| FARM 1 | LOHMANN | 90 | 63.5 | 4 | 2 | 3 | 2 |
| | WHITE | | | | | | |
| FARM 2 | BOVANS WHITE | 55 | 59.3 | 1 | 0 | 0 | 0 |
| FARM 3 | ISA BROWN | 80 | 61 | 3 | 0 | 0 | 0 |
| FARM 4 | BOVANS WHITE | 48 | 56.5 | 1 | 3 | 0 | 1 |
| FARM 5 W | BOVANS WHITE | 19 | 45 | 0 | 0 | 0 | 0 |
| FARM 5 E | ISA BROWN | 19 | 48.3 | 0 | 2 | 0 | 0 |
| FARM 5 B | ISA BROWN | 19 | 47.5 | 0 | 0 | 0 | 0 |
| FARM 6 | HISEX BROWN | 27 | 56 | 1 | 0 | 0 | 0 |
| FARM 7 | ISA BROWN | 56 | 60 | 2 | 0 | 0 | 0 |
| FARM 8 | LOHMANN | 66 | 63.5 | 3 | 3 | 1 | 1 |
| | WHITE | | | | | | |
| FARM 9 | EMPTY | 0 | 0 | 0 | 0 | 0 | 0 |
| FARM 10 | LOHMANN | 22 | 61.5 | 0 | 2 | 1 | 0 |
| | WHITE | | | | | | |
| FARM 11 | HISEX WHITE | 54 | 59.3 | 1 | 0 | 1 | 0 |
| FARM 12 | BOVANS WHITE | 64 | 61 | 3 | 1 | 3 | 2 |
| AVERAGE | — | — | 61.9 | 2.3 | 3.25 | 1.07 | 0.71 |

TECHNICAL VISIT 36 WEEKS LATER

| | | | | | | | |
|---|---|---|---|---|---|---|---|
| FARM 1 | LOHMANN | 126 | 64.3 | 2 | 3 | 1 | 0 |
| | WHITE | | | | | | |

NOTE:
CAMPOHAS 2.1% OF CRACKS BUTARRIVES AT THE EGG ROOM WITH6.5%

TABLE 9
Eggshell quality report - Farm in Minas Gerais

| | | AGE/ | PROD. | REAL | | | | THIN | | |
|---|---|---|---|---|---|---|---|---|---|---|
| FARMS | LINEAGE | WEEKS | 01/22 | WEIGHT | CRACK | DEFORM. | FAILED | SHELL | DIRTY | POROUS |
| 2 | LOHMANN | 57 | 3.52 | 61.1 | 1 | 0 | 1 | 0 | 0 | 0 |
| | WHITE | | | | | | | | | |
| 4 | BOVANS | 21 | 0.58 | 53.5 | 0 | 0 | 0 | 0 | 0 | 0 |
| | WHITE | | | | | | | | | |
| 5 | BOVANS | 43 | 2.16 | 62.3 | 1 | 0 | 1 | 0 | 0 | 0 |
| | WHITE | | | | | | | | | |
| 7 | LOHMANN | 99 | −1.28 | 67.8 | 4 | 2 | 3 | 2 | 0 | 3 |
| | WHITE | | | | | | | | | |
| 9 | HISEX WHITE | 77 | 2.88 | 65.3 | 1 | 1 | 1 | 0 | 0 | 1 |
| 10 | LOHMANN | 85 | −2.36 | 66.6 | 3 | 5 | 2 | 1 | 0 | 2 |
| | WHITE | | | | | | | | | |
| AVERAGE | | 64 | 0.9 | 62.8 | 2.8 | 4.6 | 2.2 | 0.8 | 0.0 | 1.7 |

TECHNICAL VISIT 8 WEEKS LATER

| | | | | | | | | | | |
|---|---|---|---|---|---|---|---|---|---|---|
| 2 | LOHMANN | 65 | 3.44 | 60.5 | 0 | 0 | 0 | 0 | 0 | 0 |
| | WHITE | | | | | | | | | |
| 4 | BOVANS | 29 | 2.1 | 59.4 | 0 | 0 | 0 | 0 | 0 | 0 |
| | WHITE | | | | | | | | | |
| 5 | BOVANS | 51 | 2.21 | 61.5 | 0 | 0 | 0 | 0 | 0 | 0 |
| | WHITE | | | | | | | | | |
| 7 | LOHMANN | 107 | −1.15 | 64 | 2 | 2 | 0 | 1 | 0 | 1 |
| | WHITE | | | | | | | | | |
| 9 | HISEX WHITE | 85 | 2.18 | 61.6 | 0 | 1 | 0 | 0 | 0 | 0 |
| 10 | LOHMANN | 93 | −1.94 | 62.1 | 1 | 3 | 1 | 0 | 1 | 0 |
| | WHITE | | | | | | | | | |

### Example 4: Assessment of the Use of the Emulsifier in Cattle Feed

### A) Slaughter Cattle—Paraná

The study was carried out with a total of 40 animals from a farm in the city of Prudentópolis, state of Paraná. In the study, 20 animals received feed containing 7 grams per day of the emulsifier of the present invention e 20 received feed without the product. The animals were slaughtered in 2 different slaughterhouses (Argus and Maria Macia), always in batches of 10 treated animals (positive control) against 10 witnesses (negative control).

The farmer's cost per animal was R$7.35 a month and the animals received the product for 3 months, with the resulting cost of R$22.05 per animal. In addition, the use of the emulsifier in the feed formulation improved carcass yield between 1.5% and above 2% which resulted in a profit, for the farmer, between R$197 and R$321 per livestock unit. The data obtained are depicted in the table below.

### B) Slaughter Cattle-São Paulo

Similar to the study conducted in the state of Paraná, this study was carried out on 40 animals from a farm in the city of Registro, state of São Paulo. The animals received supplementation containing 7 grams per day of the emulsifier of the present invention. As a response, the animals showed a carcass yield 1.5% above the control.

The results show improved productivity of animals based on carcass measurements, demonstrating the efficacy of using emulsifier comprising ricinoleic acid.

TABLE 10
Weight comparison of animals with and without
the use of the emulsifier (polyol)

| | | | | | MARIA MACIA | | | |
|---|---|---|---|---|---|---|---|---|
| ARGUS SLAUGHTERHOUSE | | | | | SLAUGHTERHOUSE | | | |
| | Animals (total: 20) | | | | Animals (total: 20) | | | |
| | Treatment | | | | Treatment | | | |
| | with polyol | | Control | | with polyol | | Control | |
| Carcass yield | 56.62% | | 53.937% | | 55.197% | | 53.592% | |
| Average live | 623 | kg | 635 | kg | 609 | kg | 650.8 | kg |
| weight | | | | | | | | |
| Average carcass | 352.75 | kg | 342.5 | kg | 336.15 | kg | 348.78 | kg |
| weight | | | | | | | | |

While preferred embodiments of the present disclosure have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A method of increasing absorption of calcium and phosphorous in the digestive track of a subject, comprising administering to the subject a composition and a dietary formulation, wherein the composition comprises:
a. an emulsifier derived from ricinoleic acid;
b. one or more mineral sources of calcium;
c. one or more sources of silica in solid form.

2. (canceled)

3. The method of claim 1, wherein the one or more mineral sources of calcium is present in an amount of about 10 percent to about 30 percent by weight.

4. The method of claim 3, wherein that the one or more mineral sources of calcium is calcium carbonate.

5. The method of claim 1, wherein the one or more sources of silica in solid form is present in an amount of about 5 percent to about 30 percent by weight.

6. The method of claim 1, wherein that the one or more sources of silica in solid form comprises diatomaceous earth.

7. The method of claim 1, characterized by wherein the emulsifier derived from ricinoleic acid is present in an amount of about 10 percent to about 30 percent by weight.

8. The method of claim 1, wherein the subject is a farm animal.

9. (canceled)

10. The method of claim 1, wherein the dietary formulation comprises corn, soybean meal, wheat, rice, cereals, legumes, or any combination thereof.

11. The method of claim 1, wherein the dietary formulation does not contain phosphates, meat, and bone meal.

12. The method of claim 1, wherein the composition is added to the dietary formulation in an amount of about 50 mg to about 2 kg of the composition per ton of the dietary formulation.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. The method of claim 1 wherein the emulsifier derived from ricinoleic acid comprises a soap and polyol of ricinoleic acid.

27. The method of claim 8, wherein the farm animal is selected from the group consisting of: poultry, cows, pig, fish, and sheep.

28. The method of claim 8, wherein the emulsifier improves the egg shell stability of the poultry.

29. The method of claim 8, wherein the emulsifier improves animal productivity of a cow.

30. The method of claim 8, wherein the emulsifier improves the absorption of calcium and phosphorous from vegetable macroingredients of an animal diet.

31. (canceled)

32. (canceled)

33. (canceled)

34. (canceled)

35. (canceled)

36. (canceled)

37. (canceled)

38. A composition comprising:
a. an emulsifier derived from ricinoleic acid;
b. one or more mineral sources of calcium; and
c. one or more sources of silica in solid form.

39. The composition of claim 38, wherein the one or more mineral sources of calcium is present in an amount of about 10 percent to about 30 percent by weight.

40. Composition of claim 38, wherein the one or more sources of silica in solid form is present in an amount of about 5 percent to about 30 percent by weight.

41. The composition of claim 38, wherein the emulsifier derived from ricinoleic acid is present in an amount of about 10 percent to about 30 percent by weight.

42. The composition of claim 38, wherein the emulsifier derived from ricinoleic acid comprises a soap and polyol of ricinoleic acid.

43. The composition of claim 38, further comprising a dietary formulation.
